(19) United States
(12) Patent Application Publication
(10) Pub. No.: US 2026/0111713 A1
(43) Pub. Date: Apr. 23, 2026

(54) System and Method for Performing Semantic Compression of Data within a Storage System Using Multi-modal Generative Artificial Intelligence (AI) Models

(71) Applicant: Dell Products L.P., Round Rock, TX (US)

(72) Inventor: Vamsi Vankamamidi, Hopkinton, MA (US)

(21) Appl. No.: 18/924,040

(22) Filed: Oct. 23, 2024

(51) Int. Cl. G06N 3/0475; G06N 3/042

(52) U.S. Cl. CPC G06N 3/0475; G06N 3/042

(57) ABSTRACT

A method, computer program product, and computing system for receiving a data object for storage within a storage system. A semantic representation of the data object is generated by processing the data object with a multi-modal generative artificial intelligence (AI) model. A fidelity score associated with the semantic representation is generated by processing the semantic representation using the multi-modal generative AI model. In response to determining that the fidelity score associated with the semantic representation is greater than a predefined threshold, the semantic representation is stored within the storage system in place of the data object.

### BACKGROUND

Traditional storage technologies have predominantly concentrated on raw memorization of user objects, employing an array of compression and deduplication techniques to economize on space. These techniques vary in their approach, with some being lossy and others loss-less, influencing the extent of capacity savings based on the chosen technique. However, these conventional strategies lack a fundamental comprehension of the objects they encode; they do not discern the nature or content of the images, such as whether they portray animals or vehicles.

### SUMMARY OF DISCLOSURE

In one example implementation, a computer-implemented method executed on a computing device may include, but is not limited to, receiving a data object for storage within a storage system. A semantic representation of the data object is generated by processing the data object with a multi-modal generative artificial intelligence (AI) model. A fidelity score associated with the semantic representation is generated by processing the semantic representation using the multi-modal generative AI model. In response to determining that the fidelity score associated with the semantic representation is greater than a predefined threshold, the semantic representation is stored within the storage system in place of the data object.

One or more of the following example features may be included. The data object may be processed using the multi-modal generative AI model to generate a summarized representation of the data object. Generating the semantic representation of the data object may include generating a semantic representation of the summarized representation of the data object. Generating the fidelity score may include generating a candidate representation of the data object using the semantic representation. Generating the candidate representation of the data object may include generating the candidate representation of the data object by processing the semantic representation with the multi-modal generative AI model. In response to determining that the fidelity score associated with the semantic representation is less than the predefined threshold, the candidate representation of the data object may be modified until the fidelity score is greater than the predefined threshold. A request to access the semantic representation from the storage system may be received and a reconstructed representation of the semantic representation may be generated by processing the semantic representation from the storage system with the multi-modal generative AI model.

In another example implementation, a computer program product resides on a computer readable medium that has a plurality of instructions stored on it. When executed by a processor, the instructions cause the processor to perform operations that may include, but are not limited to, receiving a data object for storage within a storage system. A semantic representation of the data object is generated by processing the data object with a multi-modal generative artificial intelligence (AI) model. A fidelity score associated with the semantic representation is generated by processing the semantic representation using the multi-modal generative AI model. In response to determining that the fidelity score associated with the semantic representation is greater than a predefined threshold, the semantic representation is stored within the storage system in place of the data object.

One or more of the following example features may be included. The data object may be processed using the multi-modal generative AI model to generate a summarized representation of the data object. Generating the semantic representation of the data object may include generating a semantic representation of the summarized representation of the data object. Generating the fidelity score may include generating a candidate representation of the data object using the semantic representation. Generating the candidate representation of the data object may include generating the candidate representation of the data object by processing the semantic representation with the multi-modal generative AI model. In response to determining that the fidelity score associated with the semantic representation is less than the predefined threshold, the candidate representation of the data object may be modified until the fidelity score is greater than the predefined threshold. A request to access the semantic representation from the storage system may be received and a reconstructed representation of the semantic representation may be generated by processing the semantic representation from the storage system with the multi-modal generative AI model.

In another example implementation, a computing system includes at least one processor and at least one memory architecture coupled with the at least one processor, wherein the at least one processor is configured to receive a data object for storage within a storage system. A semantic representation of the data object is generated by processing the data object with a multi-modal generative artificial intelligence (AI) model. A fidelity score associated with the semantic representation is generated by processing the semantic representation using the multi-modal generative AI model. In response to determining that the fidelity score associated with the semantic representation is greater than a predefined threshold, the semantic representation is stored within the storage system in place of the data object.

One or more of the following example features may be included. The data object may be processed using the multi-modal generative AI model to generate a summarized representation of the data object. Generating the semantic representation of the data object may include generating a semantic representation of the summarized representation of the data object. Generating the fidelity score may include generating a candidate representation of the data object using the semantic representation. Generating the candidate representation of the data object may include generating the candidate representation of the data object by processing the semantic representation with the multi-modal generative AI model. In response to determining that the fidelity score associated with the semantic representation is less than the predefined threshold, the candidate representation of the data object may be modified until the fidelity score is greater than the predefined threshold. A request to access the semantic representation from the storage system may be received and a reconstructed representation of the semantic representation may be generated by processing the semantic representation from the storage system with the multi-modal generative AI model.

The details of one or more example implementations are set forth in the accompanying drawings and the description below. Other possible example features and/or possible example advantages will become apparent from the description, the drawings, and the claims. Some implementations may not have those possible example features and/or possible example advantages, and such possible example features and/or possible example advantages may not necessarily be required of some implementations.

### BRIEF DESCRIPTION OF THE DRAWINGS

FIG. 1 is an example diagrammatic view of a storage system and a semantic compression process coupled to a distributed computing network according to one or more example implementations of the disclosure;

FIG. 2 is an example diagrammatic view of the storage system of FIG. 1 according to one or more example implementations of the disclosure;

FIG. 3 is an example flowchart of the semantic compression process according to one or more example implementations of the disclosure;

FIG. 4 is an example diagrammatic view of the semantic compression process storing a semantic representation of a data object according to one or more example implementations of the disclosure;

FIG. 5 is an example diagrammatic view of the semantic compression process reading a stored semantic representation of a data object according to one or more example implementations of the disclosure.

Like reference symbols in the various drawings indicate like elements.

### DETAILED DESCRIPTION

### System Overview

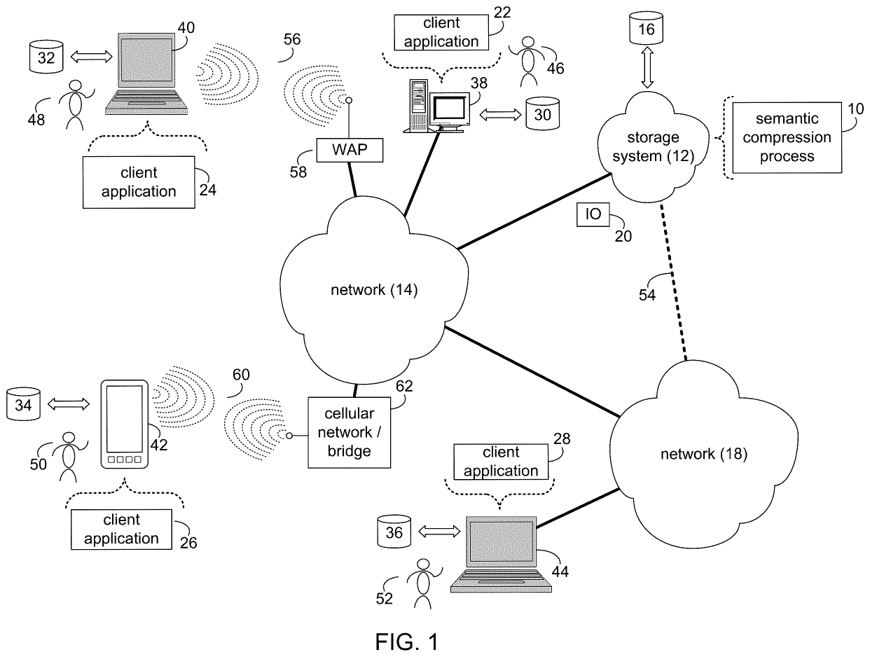

Referring to FIG. 1, there is shown semantic compression process 10 that may reside on and may be executed by storage system 12, which may be connected to network 14 (e.g., the Internet or a local area network). Examples of storage system 12 may include, but are not limited to: a Network Attached Storage (NAS) system, a Storage Area Network (SAN), a personal computer with a memory system, a server computer with a memory system, and a cloud-based device with a memory system.

As is known in the art, a SAN may include one or more of a personal computer, a server computer, a series of server computers, a minicomputer, a mainframe computer, a RAID device and a NAS system. The various components of storage system 12 may execute one or more operating systems, examples of which may include but are not limited to: Microsoft® Windows®; Mac® OS X®; Red Hat® Linux®, Windows® Mobile, Chrome OS, Blackberry OS, Fire OS, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

The instruction sets and subroutines of semantic compression process 10, which may be stored on storage device 16 included within storage system 12, may be executed by one or more processors (not shown) and one or more memory architectures (not shown) included within storage system 12. Storage device 16 may include but is not limited to: a hard disk drive; a tape drive; an optical drive; a RAID device; a random-access memory (RAM); a read-only memory (ROM); and all forms of flash memory storage devices. Additionally/alternatively, some portions of the instruction sets and subroutines of semantic compression process 10 may be stored on storage devices (and/or executed by processors and memory architectures) that are external to storage system 12.

Network 14 may be connected to one or more secondary networks (e.g., network 18), examples of which may include but are not limited to: a local area network; a wide area network; or an intranet, for example.

Various IO requests (e.g., IO request 20) may be sent from client applications 22, 24, 26, 28 to storage system 12. Examples of IO request 20 may include but are not limited to data write requests (e.g., a request that content be written to storage system 12) and data read requests (e.g., a request that content be read from storage system 12).

The instruction sets and subroutines of client applications 22, 24, 26, 28, which may be stored on storage devices 30, 32, 34, 36 (respectively) coupled to client electronic devices 38, 40, 42, 44 (respectively), may be executed by one or more processors (not shown) and one or more memory architectures (not shown) incorporated into client electronic devices 38, 40, 42, 44 (respectively). Storage devices 30, 32, 34, 36 may include but are not limited to: hard disk drives; tape drives; optical drives; RAID devices; random access memories (RAM); read-only memories (ROM), and all forms of flash memory storage devices. Examples of client electronic devices 38, 40, 42, 44 may include, but are not limited to, personal computer 38, laptop computer 40, smartphone 42, notebook computer 44, a server (not shown), a data-enabled, cellular telephone (not shown), and a dedicated network device (not shown).

Users 46, 48, 50, 52 may access storage system 12 directly through network 14 or through secondary network 18. Further, storage system 12 may be connected to network 14 through secondary network 18, as illustrated with link line 54.

The various client electronic devices may be directly or indirectly coupled to network 14 (or network 18). For example, personal computer 38 is shown directly coupled to network 14 via a hardwired network connection. Further, notebook computer 44 is shown directly coupled to network 18 via a hardwired network connection. Laptop computer 40 is shown wirelessly coupled to network 14 via wireless communication channel 56 established between laptop computer 40 and wireless access point (e.g., WAP) 58, which is shown directly coupled to network 14. WAP 58 may be, for example, an IEEE 802.11a, 802.11b, 802.11g, 802.11n, Wi-Fi, and/or Bluetooth device that is capable of establishing wireless communication channel 56 between laptop computer 40 and WAP 58. Smartphone 42 is shown wirelessly coupled to network 14 via wireless communication channel 60 established between smartphone 42 and cellular network/bridge 62, which is shown directly coupled to network 14.

Client electronic devices 38, 40, 42, 44 may each execute an operating system, examples of which may include but are not limited to Microsoft® Windows®; Mac® OS X®; Red Hat® Linux®, Windows® Mobile, Chrome OS, Blackberry OS, Fire OS, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

In some implementations, as will be discussed below in greater detail, a semantic compression process, such as semantic compression process 10 of FIG. 1, may include but is not limited to, receiving a data object for storage within a storage system. A semantic representation of the data object is generated by processing the data object with a multi-modal generative artificial intelligence (AI) model. A fidelity score associated with the semantic representation is generated by processing the semantic representation using the multi-modal generative AI model. In response to determining that the fidelity score associated with the semantic representation is greater than a predefined threshold, the semantic representation is stored within the storage system in place of the data object.

For example purposes only, storage system 12 will be described as being a network-based storage system that includes a plurality of electro-mechanical backend storage devices. However, this is for example purposes only and is not intended to be a limitation of this disclosure, as other configurations are possible and are considered to be within the scope of this disclosure.

### The Storage System

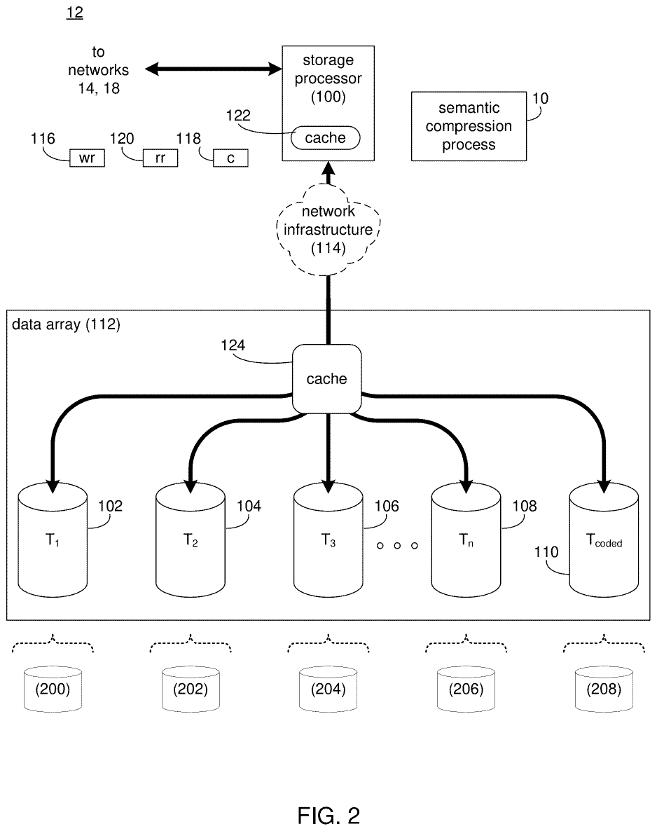

Referring also to FIG. 2, storage system 12 may include storage processor 100 and a plurality of storage targets T 1-n (e.g., storage targets 102, 104, 106, 108). Storage targets 102, 104, 106, 108 may be configured to provide various levels of performance and/or high availability. For example, one or more of storage targets 102, 104, 106, 108 may be configured as a RAID 0 array, in which data is striped across storage targets. By striping data across a plurality of storage targets, improved performance may be realized. However, RAID 0 arrays do not provide a level of high availability. Accordingly, one or more of storage targets 102, 104, 106, 108 may be configured as a RAID 1 array, in which data is mirrored between storage targets. By mirroring data between storage targets, a level of high availability is achieved as multiple copies of the data are stored within storage system 12.

While storage targets 102, 104, 106, 108 are discussed above as being configured in a RAID 0 or RAID 1 array, this is for example purposes only and is not intended to be a limitation of this disclosure, as other configurations are possible. For example, storage targets 102, 104, 106, 108 may be configured as a RAID 3, RAID 4, RAID 5 or RAID 6 array.

While in this particular example, storage system 12 is shown to include four storage targets (e.g., storage targets 102, 104, 106, 108), this is for example purposes only and is not intended to be a limitation of this disclosure. Specifically, the actual number of storage targets may be increased or decreased depending upon e.g., the level of redundancy/performance/capacity required.

Storage system 12 may also include one or more coded targets 110. As is known in the art, a coded target may be used to store coded data that may allow for the regeneration of data lost/corrupted on one or more of storage targets 102, 104, 106, 108. An example of such a coded target may include but is not limited to a hard disk drive that is used to store parity data within a RAID array.

While in this particular example, storage system 12 is shown to include one coded target (e.g., coded target 110), this is for example purposes only and is not intended to be a limitation of this disclosure. Specifically, the actual number of coded targets may be increased or decreased depending upon e.g., the level of redundancy/performance/capacity required.

Examples of storage targets 102, 104, 106, 108 and coded target 110 may include one or more electro-mechanical hard disk drives and/or solid-state/flash devices, wherein a combination of storage targets 102, 104, 106, 108 and coded target 110 and processing/control systems (not shown) may form data array 112.

The manner in which storage system 12 is implemented may vary depending upon e.g., the level of redundancy/performance/capacity required. For example, storage system 12 may be a RAID device in which storage processor 100 is a RAID controller card and storage targets 102, 104, 106, 108 and/or coded target 110 are individual “hot-swappable” hard disk drives. Another example of such a RAID device may include but is not limited to an NAS device. Alternatively, storage system 12 may be configured as a SAN, in which storage processor 100 may be e.g., a server computer and each of storage targets 102, 104, 106, 108 and/or coded target 110 may be a RAID device and/or computer-based hard disk drives. Further still, one or more of storage targets 102, 104, 106, 108 and/or coded target 110 may be a SAN.

In the event that storage system 12 is configured as a SAN, the various components of storage system 12 (e.g. storage processor 100, storage targets 102, 104, 106, 108, and coded target 110) may be coupled using network infrastructure 114, examples of which may include but are not limited to an Ethernet (e.g., Layer 2 or Layer 3) network, a fiber channel network, an InfiniBand network, or any other circuit switched/packet switched network.

Storage system 12 may execute all or a portion of semantic compression process 10. The instruction sets and subroutines of semantic compression process 10, which may be stored on a storage device (e.g., storage device 16) coupled to storage processor 100, may be executed by one or more processors (not shown) and one or more memory architectures (not shown) included within storage processor 100. Storage device 16 may include but is not limited to: a hard disk drive; a tape drive; an optical drive; a RAID device; a random-access memory (RAM); a read-only memory (ROM); and all forms of flash memory storage devices. As discussed above, some portions of the instruction sets and subroutines of semantic compression process 10 may be stored on storage devices (and/or executed by processors and memory architectures) that are external to storage system 12.

As discussed above, various IO requests (e.g., IO request 20) may be generated. For example, these IO requests may be sent from client applications 22, 24, 26, 28 to storage system 12. Additionally/alternatively and when storage processor 100 is configured as an application server, these IO requests may be internally generated within storage processor 100. Examples of IO request 20 may include but are not limited to data write request 116 (e.g., a request that content 118 be written to storage system 12) and data read request 120 (i.e., a request that content 118 be read from storage system 12).

During operation of storage processor 100, content 118 to be written to storage system 12 may be processed by storage processor 100. Additionally/alternatively and when storage processor 100 is configured as an application server, content 118 to be written to storage system 12 may be internally generated by storage processor 100.

Storage processor 100 may include frontend cache memory system 122. Examples of frontend cache memory system 122 may include but are not limited to a volatile, solid-state, cache memory system (e.g., a dynamic RAM cache memory system) and/or a non-volatile, solid-state, cache memory system (e.g., a flash-based, cache memory system).

Storage processor 100 may initially store content 118 within frontend cache memory system 122. Depending upon the manner in which frontend cache memory system 122 is configured, storage processor 100 may immediately write content 118 to data array 112 (if frontend cache memory system 122 is configured as a write-through cache) or may subsequently write content 118 to data array 112 (if frontend cache memory system 122 is configured as a write-back cache).

Data array 112 may include backend cache memory system 124. Examples of backend cache memory system 124 may include but are not limited to a volatile, solid-state, cache memory system (e.g., a dynamic RAM cache memory system) and/or a non-volatile, solid-state, cache memory system (e.g., a flash-based, cache memory system). During operation of data array 112, content 118 to be written to data array 112 may be received from storage processor 100. Data array 112 may initially store content 118 within backend cache memory system 124 prior to being stored on e.g., one or more of storage targets 102, 104, 106, 108, and coded target 110.

As discussed above, the instruction sets and subroutines of semantic compression process 10, which may be stored on storage device 16 included within storage system 12, may be executed by one or more processors (not shown) and one or more memory architectures (not shown) included within storage system 12. Accordingly, in addition to being executed on storage processor 100, some or all of the instruction sets and subroutines of semantic compression process 10 may be executed by one or more processors (not shown) and one or more memory architectures (not shown) included within data array 112.

Further and as discussed above, during the operation of data array 112, content (e.g., content 118) to be written to data array 112 may be received from storage processor 100 and initially stored within backend cache memory system 124 prior to being stored on e.g., one or more of storage targets 102, 104, 106, 108, 110. Accordingly, during use of data array 112, backend cache memory system 124 may be populated (e.g., warmed) and, therefore, subsequent read requests may be satisfied by backend cache memory system 124 (e.g., if the content requested in the read request is present within backend cache memory system 124), thus avoiding the need to obtain the content from storage targets 102, 104, 106, 108, 110 (which would typically be slower).

### The Semantic Compression Process

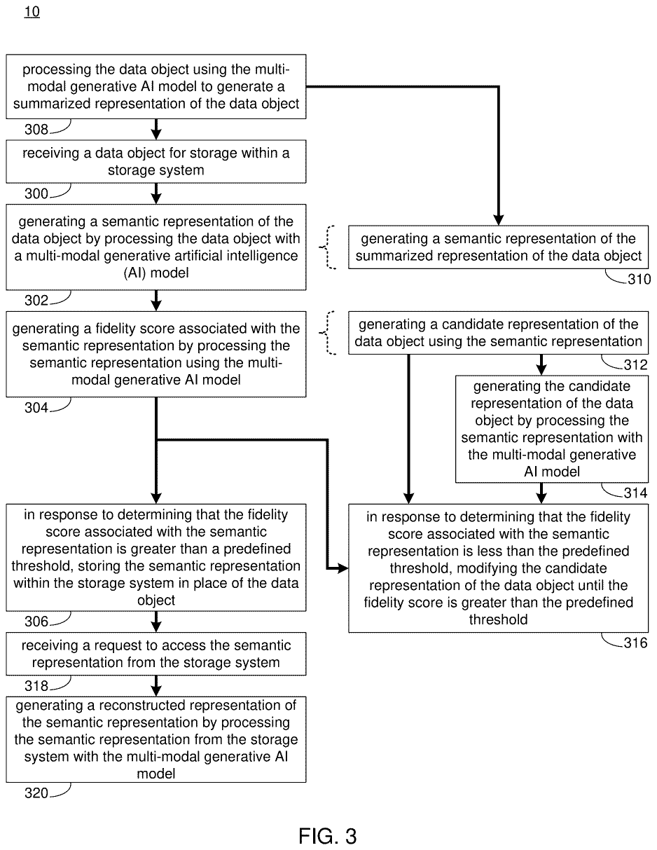

Referring also to the examples of FIGS. 3-5 and in some implementations, semantic compression process 10 may receive 300 a data object for storage within a storage system. A semantic representation of the data object is generated 302 by processing the data object with a multi-modal generative artificial intelligence (AI) model. A fidelity score associated with the semantic representation is generated 304 by processing the semantic representation using the multi-modal generative AI model. In response to determining that the fidelity score associated with the semantic representation is greater than a predefined threshold, the semantic representation is stored 306 within the storage system in place of the data object.

The advent of multi-modal generative artificial intelligence (AI) models, such as Large Language Model (LLM)s, has marked a significant leap forward, demonstrating remarkable proficiency in interpreting and understanding objects like text and images. These models can encapsulate their insights into a succinct summary of the object. Implementations of the present disclosure provide a new mechanism that leverages these recent technological advancements to realize substantial capacity savings in storage systems. Specifically, in environments where exact replicas of data objects are not imperative, thereby opening up avenues for storage efficiency. Implementations of the present disclosure employ multi-modal generative AI models to analyze (i.e., extract core meaning from various data object types (text, images, etc.)); summarize (i.e., generate condensed, information-rich representations of data objects; store data concisely by replacing original data objects with a generated summaries, thus reducing storage footprint); and retrieve data objects selectively by either reconstructing the original object (with potential imperfections) or by providing a summarized representation of the data object.

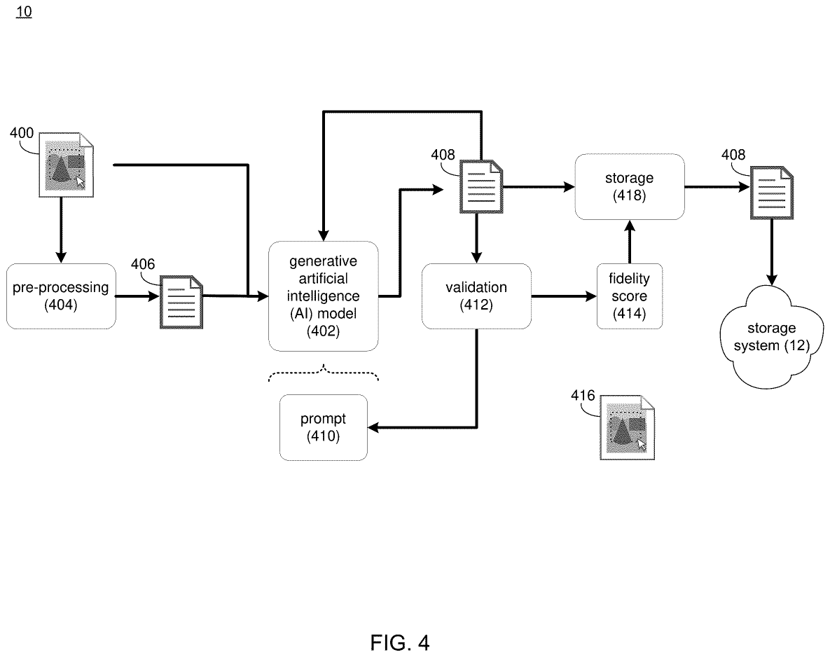

In some implementations, semantic compression process 10 receives 300 a data object for storage within a storage system. For example, a data object is a structured collection of data that can be processed, transmitted, and stored within a storage system. Referring also to FIG. 4 and in some implementations, semantic compression process 10 may receive 300 a data object (e.g., data object 400). In this example, data object 400 may be an image file. In another example, data object 400 may be a text file. In another example, data object 400 may be an audio file. In another example, data object 400 may be a video file. In another example, data object 400 may be spreadsheet file. In another example, data object 400 may be a presentation with multiple slides. In some implementations, data object 400 may be a multimedia file with multiple types of content. Accordingly, it will be appreciated that data object 400 may be of various types within the scope of the present disclosure.

In some implementations, semantic compression process 10 processes 308 the data object using a multi-modal generative artificial intelligence (AI) model to generate a summarized representation of the data object. In some implementations, a multi-modal generative AI model (e.g., generative AI model 516) is a type of artificial intelligence system that is capable of generating new data samples that are similar to the training data it has been trained with. These models generally work by learning the underlying patterns and structures present in the training data and then using this “knowledge”, they generate new, consistent examples. In some implementations, the generative AI model includes a Large Language Model (LLM). A LLM (e.g., GPT-4 from OpenAI®, OpenLLaMa, and Cerebras-GPT) is a language model consisting of a neural network with many parameters (typically billions of weights or more), trained on large quantities of unlabeled text using self-supervised learning or semi-supervised learning. Though trained on simple tasks along the lines of predicting the next word in a sentence, LLMs with sufficient training and parameter counts capture the syntax and semantics of human language. In some implementations, the generative AI model is a multi-modal generative AI model. For example, a multi-modal generative AI model is an AI system that integrates and processes multiple types of data (e.g., text, images, audio, video, etc.). By combining these different modalities, the model can understand and generated more nuanced outputs.

In some implementations, semantic compression process 10 pre-processes data object 400 by using a machine learning model to generate a summary of data object 400 that “summarizes” data object 400 to a limited description. For example, suppose data object 400 is a text file describing many examples and images. In this example, semantic compression process 10 processes 308 (e.g., where this processing is represented in FIG. 4 with “pre-processing 404”) data object 400 to generate a summarized representation (e.g., summarized representation 406). In this example, summarized representation 406 is a textual summary of the contents of data object 400 (e.g., a summary of the text, including the examples and images).

In some implementations, semantic compression process 10 generates 302 a semantic representation of the data object by processing the data object with the multi-modal generative AI model. For example, a semantic representation is an encoding of information in terms of meaning and description, allowing for a more effective processing by computing devices. For instance, in natural language processing, semantic relationships can help multi-modal generative AI model 402 to process an image as a description of its content. In one example, suppose data object 400 is an image of a lion. In this example, semantic compression process 10 generates a semantic representation (e.g., semantic representation 408) of either data object 400 to generate, in this example, a textual description of the image of the lion. For example, semantic compression process 10 provides a prompt (e.g., prompt 410) or a series of prompts to multi-modal generative AI model 402 to generate semantic representation 408 of data object 400. In one example, prompt 410 includes the following: “Can you capture description of the image in highest possible detail so that I can regenerate the image from the description?”. While prompt 410 concerns generating semantic representation 408 in terms of a textual description from an image file, it will be appreciated that semantic compression process 10 may use various prompts to generate a semantic representation of a data object from one modality to another within the scope of the present disclosure.

In some implementations, generating 302 the semantic representation of the data object includes generating 310 a semantic representation of the summarized representation of the data object. For example and as shown in FIG. 4, semantic compression process 10 may pre-process 404 data object 400 to generate summarized representation 406. Using summarized representation 406, semantic compression process 10 generates semantic representation 408 with multi-modal generative AI model 402 instead of using data object 400. In this example, semantic compression process 10 may provide a smaller input to multi-modal generative AI model 402 using summarized representation 406 which results in a more efficient generation of semantic representation 408 in terms of processing time and/or processing resources (i.e., when summarized representation 406 is a smaller data file than data object 400, the amount of memory required to generate 310 semantic representation 408 is reduced).

In some implementations, semantic compression process 10 generates 304 a fidelity score associated with the semantic representation by processing the semantic representation using the multi-modal generative AI model. For example, with semantic representation 408, semantic compression process 10 determines whether the semantic representation is an effective replacement for data object 400. In some implementations, semantic compression process 10 processes semantic representation 408 using multi-modal generative AI model 402 (represented in FIG. 4 as validation 412) by providing a prompt (or series of prompts) to multi-modal generative AI model 402. In one example, prompt 410 may be: “Can you validate how good the description of the image is by regenerating the image and provide a score between 0 and 10?” It will be appreciated that various prompts may be used to generate a fidelity score. In this example, the score generated by multi-modal generative AI model 402 is a fidelity score (e.g., fidelity score 414) indicating whether semantic representation 408 is an accurate representation of data object 400. In some implementations, semantic compression process 10 may generate multiple fidelity scores to form a composite fidelity score representative of many aspects.

In some implementations, generating 304 the fidelity score includes generating 312 a candidate representation of the data object using the semantic representation. For example, semantic compression process 10 may use semantic representation 408 to generate a candidate representation (e.g., candidate representation 416) and comparing candidate representation 416 with data object 400 to determine whether semantic representation 408 provides sufficient detail to generate candidate representation 416 that resembles data object 400. In some implementations, generating 312 the candidate representation of the data object includes generating 314 the candidate representation of the data object by processing the semantic representation with the multi-modal generative AI model. Continuing with the example of data object 400 being an image of a lion, semantic compression process 10 generates 314 candidate representation 416 from semantic representation 408 using multi-modal generative AI model 402. In this example, semantic compression process 10 generates 304 fidelity score 414 as an assessment of image features in candidate representation 416 relative to data object 400 (i.e., a comparison of: the mane and fur, the facial features, the surface and background of the image, lighting, etc.). It will be appreciated that various aspects of candidate representation 416 may be compared with features of data object 400 to generate 304 fidelity score 414 within the scope of the present disclosure.

In some implementations and in response to determining that the fidelity score associated with the semantic representation is greater than a predefined threshold, semantic compression process 10 stores 306 the semantic representation within the storage system in place of the data object. For example, a predefined threshold may be set by a user, as a default value, and/or as defined automatically by semantic compression process 10. The predefined threshold may be a value (e.g., a value between 0 and 1, where a fidelity score greater than the predefined threshold indicates that semantic representation 408 produces a sufficiently accurate reconstruction of data object 400). In some implementations, the predefined threshold may be defined for particular data types. For instance, image data objects may have one predefined threshold while an audio data object may have a different predefined threshold. A type of intended storage may also determine predefined threshold. For instance, for data objects that are frequently accessed and/or for data objects that have higher resolution, a higher predefined threshold is used. In another example, for data objects being stored in archive storage and/or for data objects with low resolution, a lower predefined threshold may be used.

In some implementations and in response to determining that the fidelity score associated with the semantic representation is less than the predefined threshold, semantic compression process 10 modifies 316 the candidate representation of the data object until the fidelity score is greater than the predefined threshold. For example, if candidate representation 416 and/or the validation 412 of semantic representation 408 generates 304 fidelity score 414 that is less than the predefined threshold, semantic compression process 10 modifies 216 candidate representation 416 and/or semantic representation 408 until an updated fidelity score is greater than the predefined threshold. In one example, semantic compression process 10 uses a prompt (e.g., prompt 410) provided to multi-modal generative AI model 402 to modify 316 candidate representation 416 and/or semantic representation 408. In one example, prompt 410 may be: “Can you enhance description of the image and validate how good the description is by regenerating the image and checking if score improved?” In this manner, semantic compression process 10 modifies 316 candidate representation 416 and/or semantic representation 408 by providing a prompt (or a series of prompts) to multi-modal generative AI model 402 to produce an updated candidate representation and/or an updated semantic representation. An updated fidelity score is generated, and this is repeatedly iteratively until fidelity score 414 is greater than the predefined threshold, or a maximum fidelity score is achieved without exceeding the predefined threshold after a threshold number of iterations.

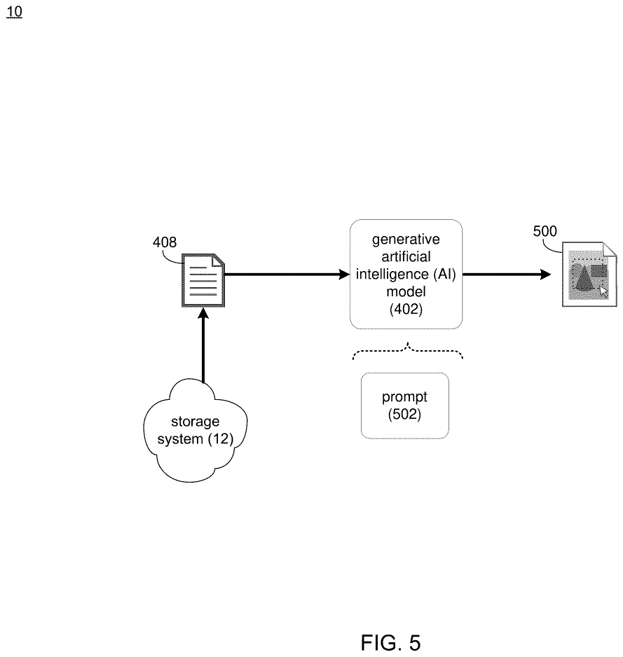

In some implementations, semantic compression process 10 receives 318 a request to access the semantic representation from the storage system and generates 320 a reconstructed representation of the semantic representation by processing the semantic representation from the storage system with the multi-modal generative AI model. Referring also to FIG. 5, semantic compression process 10 receives 318 a request to access semantic representation 408 from storage system 12. In some implementations, semantic compression process 10 generates 320 a reconstructed representation (e.g., reconstructed representation 500) by processing a prompt (e.g., prompt 502) on multi-modal generative AI model 402. In some implementations, prompt 502 directs multi-modal generative AI model 402 to generate reconstructed representation 500 using semantic representation 408.

In some implementations, the storage of semantic representation 408 may result in significant memory savings. For example, an image with an original size of two megabytes can be stored as semantic representation requiring only four kilobytes. As such, where conventional data compression approaches focus on physical data compression, semantic compression process 10 leverage multi-modal generative AI models to determine and store a semantic representation of a data object. In this manner, semantic compression process 10 allows for enhanced data storage efficiency.

### General

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object-oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet (e.g., network 14).

The present disclosure is described with reference to flowchart illustrations and/or block diagrams of methods, apparatus (systems) and computer program products according to implementations of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various implementations of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular implementations only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various implementations with various modifications as are suited to the particular use contemplated.

A number of implementations have been described. Having thus described the disclosure of the present application in detail and by reference to implementations thereof, it will be apparent that modifications and variations are possible without departing from the scope of the disclosure defined in the appended claims.

What is claimed is:

1. A computer-implemented method, executed on a computing device, comprising:
receiving a data object for storage within a storage system;
generating a semantic representation of the data object by processing the data object with a multi-modal generative artificial intelligence (AI) model;
generating a fidelity score associated with the semantic representation by processing the semantic representation using the multi-modal generative AI model; and
in response to determining that the fidelity score associated with the semantic representation is greater than a predefined threshold, storing the semantic representation within the storage system in place of the data object.

2. The computer-implemented method of claim 1, further comprising:
processing the data object using the multi-modal generative AI model to generate a summarized representation of the data object.

3. The computer-implemented method of claim 2, wherein generating the semantic representation of the data object includes generating a semantic representation of the summarized representation of the data object.

4. The computer-implemented method of claim 1, wherein generating the fidelity score includes generating a candidate representation of the data object using the semantic representation.

5. The computer-implemented method of claim 4, wherein generating the candidate representation of the data object includes generating the candidate representation of the data object by processing the semantic representation with the multi-modal generative AI model.

6. The computer-implemented method of claim 5, further comprising:
in response to determining that the fidelity score associated with the semantic representation is less than the predefined threshold, modifying the candidate representation of the data object until the fidelity score is greater than the predefined threshold.

7. The computer-implemented method of claim 1, further comprising:
receiving a request to access the semantic representation from the storage system; and
generating a reconstructed representation of the semantic representation by processing the semantic representation from the storage system with the multi-modal generative AI model.

8. A computer program product residing on a non-transitory computer readable medium having a plurality of instructions stored thereon which, when executed by a processor, cause the processor to perform operations comprising:
receiving a data object for storage within a storage system;
generating a semantic representation of the data object by processing the data object with a multi-modal generative artificial intelligence (AI) model;
generating a fidelity score associated with the semantic representation by processing the semantic representation using the multi-modal generative AI model; and
in response to determining that the fidelity score associated with the semantic representation is greater than a predefined threshold, storing the semantic representation within the storage system in place of the data object.

9. The computer program product of claim 8, wherein the operations further comprise:
processing the data object using the multi-modal generative AI model to generate a summarized representation of the data object.

10. The computer program product of claim 8, wherein generating the semantic representation of the data object includes generating a semantic representation of the summarized representation of the data object.

11. The computer program product of claim 8, wherein generating the fidelity score includes generating a candidate representation of the data object using the semantic representation.

12. The computer program product of claim 11, wherein generating the candidate representation of the data object includes generating the candidate representation of the data object by processing the semantic representation with the multi-modal generative AI model.

13. The computer program product of claim 12, wherein the operations further comprise:
in response to determining that the fidelity score associated with the semantic representation is less than the predefined threshold, modifying the candidate representation of the data object until the fidelity score is greater than the predefined threshold.

14. The computer program product of claim 13, wherein the operations further comprise:
receiving a request to access the semantic representation from the storage system; and
generating a reconstructed representation of the semantic representation by processing the semantic representation from the storage system with the multi-modal generative AI model.

15. A computing system comprising:
a memory; and
a processor configured to receive a data object for storage within a storage system, to generate a semantic representation of the data object by processing the data object with a multi-modal generative artificial intelligence (AI) model, to generate a fidelity score associated with the semantic representation by processing the semantic representation using the multi-modal generative AI model, and in response to determining that the fidelity score associated with the semantic representation is greater than a predefined threshold, to store the semantic representation within the storage system in place of the data object.

16. The computing system of claim 15, wherein the processor is further configured to:
process the data object using the multi-modal generative AI model to generate a summarized representation of the data object.

17. The computing system of claim 15, wherein generating the semantic representation of the data object includes generating a semantic representation of the summarized representation of the data object.

18. The computing system of claim 15, wherein generating the fidelity score includes generating a candidate representation of the data object using the semantic representation.

19. The computing system of claim 18, wherein generating the candidate representation of the data object includes generating the candidate representation of the data object by processing the semantic representation with the multi-modal generative AI model.

20. The computing system of claim 19, wherein the processor is further configured to:
in response to determining that the fidelity score associated with the semantic representation is less than the predefined threshold, modifying the candidate representation of the data object until the fidelity score is greater than the predefined threshold.
